(19) United States
(12) Patent Application Publication
(10) Pub. No.: US 2014/0125784 A1
(43) Pub. Date: May 8, 2014

(54) DISPLAY CONTROL APPARATUS, DISPLAY CONTROL METHOD, AND PROGRAM

(71) Applicant: SONY CORPORATION, Tokyo (JP)

(72) Inventors: Ryo Fukazawa, Kanagawa (JP); Yusuke Kudo, Kanagawa (JP); Takeo Tsukamoto, Tokyo (JP)

(73) Assignee: SONY CORPORATION, Tokyo (JP)

(21) Appl. No.: 14/118,658

(22) PCT Filed: Jun. 6, 2012
(86) PCT No.: PCT/JP12/03694

§ 371 Date: Nov. 19, 2013

(30) Foreign Application Priority Data
Jun. 13, 2011 (JP) 2011-131298

(51) Int. Cl. H04N 13/04; H04N 21/482

(52) U.S. Cl. CPC H04N 13/0488; H04N 21/4821
USPC 348/51

(57) ABSTRACT

An apparatus includes a detection section and a display controller. The detection section is configured to detect an operation input. The display controller is configured to control a display to display a plurality of objects, the display controller configured to control the display to select at least one of the plurality of objects based on the operation input, to modify a depth component of a display position of the at least one object selected, and to display the at least one object selected at the display position having the depth component modified.

### TECHNICAL FIELD

The present invention relates to a display control apparatus, a display control method, and a program encoded on a non-transitory computer readable medium, and, in particular, to a display control apparatus, a display control method, and a program which improve, for example, visibility corresponding to a plurality of pieces of information which is displayed on a screen.

### BACKGROUND ART

Recently, a so-called 3-Dimensional (3D) TV receiver, in which a screen can be stereoscopically viewed, has been attracting attention.

In such a 3D TV receiver, content, such as a video image or the like, is displayed as a 3D image. Meanwhile, an Electronic Program Guide (EPG) is displayed as a 2D image which is viewed in a plane.

Meanwhile, with respect to the display of the EPG, there is a stereoscopic display technology which allows program titles or the like to be stereoscopically displayed using depths according to the popularity of the corresponding programs (for example, refer to Patent Literature 1).

### CITATION LIST

### Patent Literature

PTL 1: Japanese Unexamined Patent Application Publication No. 2009-147550

### SUMMARY OF INVENTION

### Technical Problem

Since the EPG is displayed as a 2D image in the above-described 3D TV receiver, it is difficult to easily find, for example, a desired information display (for example, the information display of programs belonging to the same genre) from among a plurality of information displays, and the visibility thereof is singularly bad.

Further, according to the above-described stereoscopic display technology, the popularity of a program corresponding to the information display can be easily recognized based on the depth of the information display. However, it is difficult to easily find a desired information display, hence visibility is bad.

The present invention has been made with the above situations in mind, and improves visibility corresponding to a plurality of pieces of information displayed on a screen.

### Solution to Problem

Accordingly, the present invention broadly comprises an apparatus, a method, and a non-transitory computer readable medium encoded with a program which causes the processor to perform the method. In one embodiment, the apparatus includes a detection section and a display controller. The detection section is configured to detect an operation input. The display controller is configured to control a display to display a plurality of objects, the display controller configured to control the display to select at least one of the plurality of objects based on the operation input, to modify a depth component of a display position of the at least one object selected, and to display the at least one object selected at the display position having the depth component modified.

### Advantageous Effects of Invention

According to the present invention, visibility corresponding to the plurality of pieces of information displayed on a screen can be improved.

### BRIEF DESCRIPTION OF DRAWINGS

FIG. 1 is a block diagram illustrating an example of the configuration of a TV receiver according to a present embodiment.

FIG. 2 is a view illustrating an example of a display screen.

FIG. 3 is a view illustrating another example of the display screen.

FIG. 4 is a first view illustrating a principle in order to perform stereoscopic display.

FIG. 5 is a second view illustrating the principle in order to perform the stereoscopic display.

FIG. 6 is a third view illustrating the principle in order to perform the stereoscopic display.

FIG. 7 is a flowchart illustrating a display process performed by the TV receiver.

FIG. 8 is a block diagram illustrating an example of the configuration of a computer.

FIG. 9 is a view illustrating another example of a display screen.

FIG. 10 is a view illustrating a further example of a display screen.

FIG. 11 is a view illustrating an additional example of a display screen.

### DESCRIPTION OF EMBODIMENTS

Hereinafter, an embodiment of the present invention (hereinafter, referred to as present embodiment) will be described. Meanwhile, description will be performed in the following order:

1. Present embodiment (an example when the visibility of an EPG, which is configured with information displays, is improved by changing the depths of information displays)

2. Modification

### 1. Present Embodiment

Example of Configuration of TV Receiver 1

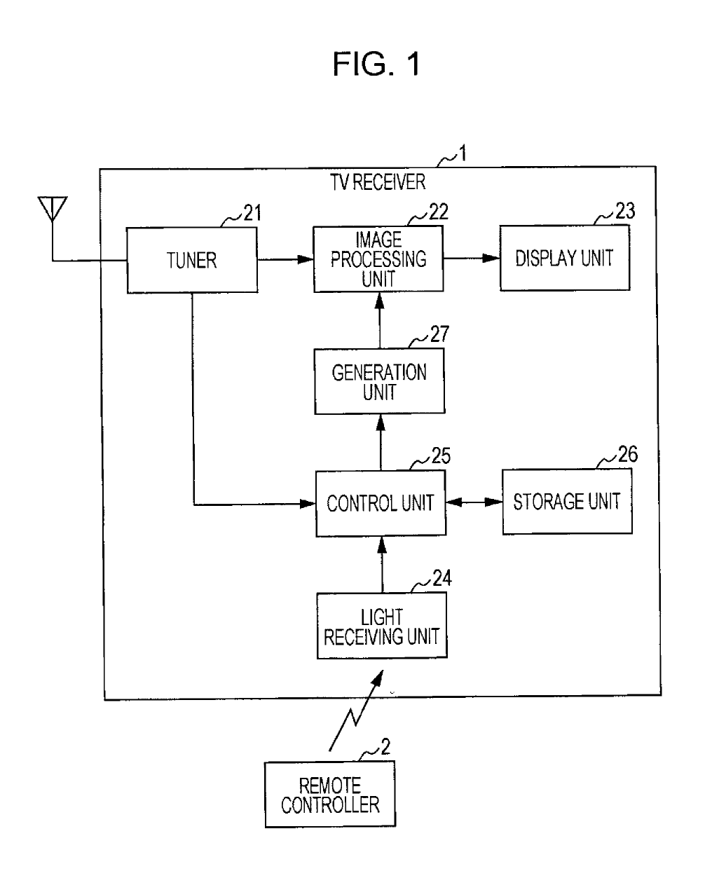

FIG. 1 illustrates an example of the configuration of a TV receiver 1 which is the present embodiment.

The TV receiver 1 displays a stereoscopically visible EPG based on a manipulation signal from, for example, a remote controller 2.

The TV receiver 1 includes a tuner 21, an image processing unit 22, a display unit 23, a light receiving unit 24, a control unit 25, a storage unit 26, and a generation unit 27.

The tuner 21 receives a broadcast signal via an antenna or the like, extracts an image signal corresponding to a selected channel (frequency bandwidth) from the received broadcast signal, and then supplies the extracted image signal to the image processing unit 22. Further, the tuner 21 extracts an EPG, included in the broadcast signal, from the received broadcast signal, and then supplies the extracted EPG to the control unit 25.

The image processing unit 22 supplies the image signal received from the tuner 21 to the display unit 23, and displays a corresponding image. Further, when the EPG is supplied from the generation unit 27 as a 3D image, the image processing unit 22 superimposes the EPG from the generation unit 27 on the image corresponding to the image signal received from the tuner 21, supplies an image which is obtained as the result of the superimposing to the display unit 23, and displays the image on the display unit 23.

The display unit 23 is, for example, a Liquid Crystal Display (LCD) or the like, and displays the image from the image processing unit 22. The light receiving unit 24 receives the manipulation signal from the remote controller 2, and supplies the manipulation signal to the control unit 25.

The control unit 25 supplies the EPG received from the tuner 21 and stores the EPG in the storage unit 26. Further, the control unit 25 controls the tuner 21, the image processing unit 22, and the generation unit 27 based on, for example, the manipulation signal received from the light receiving unit 24.

That is, for example, when the manipulation signal, which instructs the control unit 25 to display the EPG, is supplied from the light receiving unit 24, the control unit 25 reads the EPG from the storage unit 26. Thereafter, the control unit 25 supplies the read EPG to the generation unit 27.

The storage unit 26 stores the EPG from the control unit 25 in addition to a control program or the like executed by the control unit 25.

The generation unit 27 generates a 3D image, in which the program display sections which configure the EPG can be stereoscopically viewed, based on the EPG from the control unit 25 under the control of the control unit 25, and then supplies the 3D image to the image processing unit 22.

Meanwhile, the 3D image is configured with a left eye 2D image which indicates an EPG which is configured to be viewed by the left eye of a user (viewer) and a right eye 2D image which indicates an EPG which is configured to be viewed by the right eye of the user.

Further, between a program display section which configures the EPG as the left eye 2D image and a program display section which configures the EPG as the right eye 2D image, a parallax is provided such that program display sections on the 3D image, which are viewed by the user, are stereoscopically viewed. Here, the parallax indicates the deviation between the position of the program display section on the left eye 2D image and the position of the program display section on the right eye 2D image.

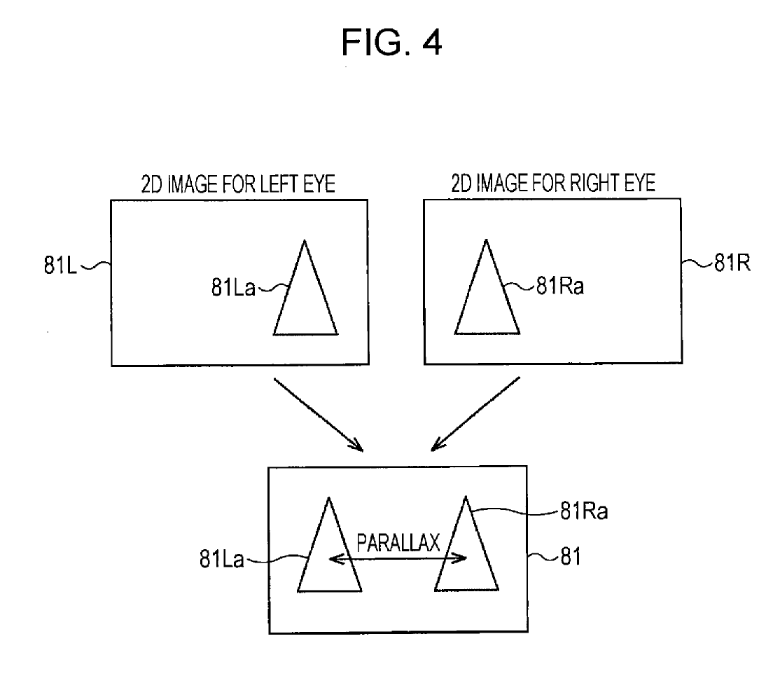

Meanwhile, the program display section on the 3D image is stereoscopically viewed using a depth according to the parallax provided to the program display section. This will be described in detail with reference to FIGS. 4 to 6 which will be described later.

<Example of Display Screen>

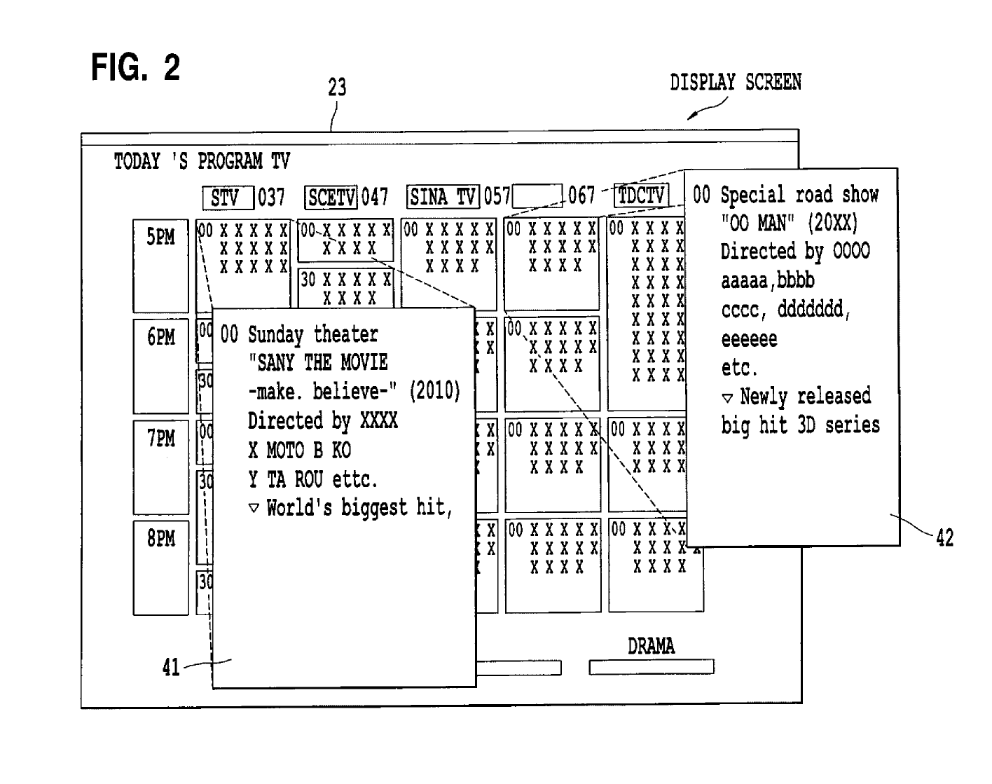

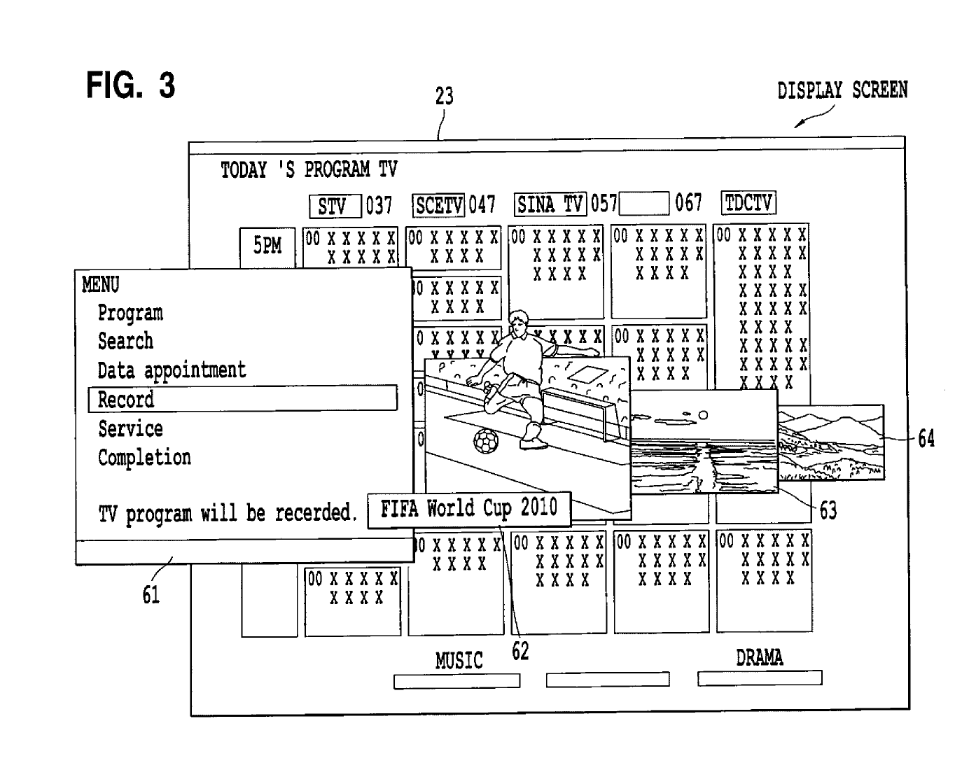

Next, an example of an EPG displayed on the display unit 23 will be described with reference to FIGS. 2 and 3.

FIG. 2 illustrates an example of a 3D image when program display sections, which indicate pieces of information about programs which satisfy with a condition that the programs belong to the same genre, are displayed in the same depth.

In FIG. 2, from among a plurality of program display sections which configure the EPG, a program display section 41 and a program display section 42 of programs which belonging to the same genre “movie” are displayed on the front side of the display screen of the display unit 23 in the same depth. Meanwhile, the depth is defined using a Z-axis (not shown) which is defined in the normal line direction of the display screen. In the Z-axis, the depth becomes large as the program display section proceeds to the side of the display screen and the depth becomes small as the program display section proceeds to the front side of the display screen.

For example, when the user wants to distinguish program display sections of programs which belonging to the same genre “movie” from other program display sections, and emphasize and display the program display sections, the user manipulates the remote controller 2 as described below. That is, the user manipulates the remote controller 2 such that, for example, the user can distinguish the program display sections of the programs which belonging to the same genre “movie” from other program display sections, and emphasize and display these program display sections. In this case, the remote controller 2 outputs a corresponding manipulation signal to the light receiving unit 24. The light receiving unit 24 receives the manipulation signal from the remote controller 2, and supplies the manipulation signal to the control unit 25.

Further, when the manipulation signal is supplied from the light receiving unit 24, the control unit 25 reads the EPG from the storage unit 26, and supplies the EPG to the generation unit 27. Further, the control unit 25 controls the generation unit 27 and the image processing unit 22, and displays a 3D image functioning as the EPG on the display unit 23, as shown in FIG. 2.

That is, for example, the generation unit 27 generates the 3D image (the left eye 2D image and the right eye 2D image), in which the amount of parallax (parallax amount) of the program display sections 41 and 42 is greater than the parallax amount of other program display sections, based on the EPG from the control unit 25.

In detail, for example, the generation unit 27 generates each program display section as a 3D image on the display unit 23 using each program display section which configures the EPG supplied from the control unit 25. Further, the generation unit 27 generates 3D display position information which indicates a 3D display position at which each generated program display section is displayed. Meanwhile, the 3D display position is defined on the display screen of the display unit 23 by an X-axis which indicates a position in the horizontal direction and a Y-axis which indicates a position in the vertical direction in addition to the Z-axis which indicates depth. Further, as described above, when the remote controller 2 is manipulated by the user, the generation unit 27 selects the program display sections 41 and 42 which will be emphasized and displayed from each program display section, and modifies the 3D display position information of the selected program display sections 41 and 42 under the control of the control unit 25. That is, for example, the generation unit 27 modifies the 3D display position information such that the depth of each of the 3D display positions of the selected program display sections 41 and 42 is different from the depths of other program display sections. Therefore, the 3D display position information of each program display section becomes information which indicates the 3D display position in which each program display section is displayed as shown in FIG. 2. Meanwhile, when the remote controller 2 is manipulated by the user, the generation unit 27 may generate each program display section for indication and the 3D display position information, and then modify the 3D display position information.

Thereafter, the generation unit 27 generates the above-described 3D image by rendering (drawing) the left eye 2D image and the right eye 2D image based on each program display section generated, 3D display position information which is generated for each program display section, and the right and left view points of the user which are virtually determined.

Therefore, the 3D image, in which the parallax amount of the program display sections 41 and 42 is greater than the parallax amount of other program display sections, is generated by the generation unit 27. That is, the 3D image in which the program display sections 41 and 42 are viewed in front of other program display sections is generated.

The image processing unit 22 superimposes the 3D image functioning as the EPG from the generation unit 27 on an image corresponding to the image signal from the tuner 21 under the control from the control unit 25, and then supplies the superimposed image obtained as the result of the superimposition to the display unit 23 and displays on the display unit 23. Therefore, the stereoscopic EPG, as shown in FIG. 2, is displayed on the display screen of the display unit 23.

Meanwhile, in FIG. 2, in order to emphasize and display the program display sections 41 and 42, the depths of the program display sections 41 and 42 of the plurality of program display sections which configure the EPG are displayed in the same depth which is different from the depths of the program display sections excluding the program display sections 41 and 42.

However, a method of emphasizing and displaying the program display sections 41 and 42 is not limited thereto. That is, for example, when a setting is made such that the depths of the program display sections 41 and 42 are different from the depths of the program display sections excluding the program display sections 41 and 42, the program display section 41 and the program display section 42 may be displayed in respective depths which are different from each other.

In addition, for example, the depth of a first program display section which is present around each of the program display sections 41 and 42 may be displayed in a depth which is different from the depth of program display sections (including the program display sections 41 and 42) excluding the first program display section from among the plurality of program display sections which configure the EPG, so that the program display sections 41 and 42 can be emphasized and displayed.

Next, FIG. 3 illustrates an example of the EPG in the case where the program display sections are displayed in different depths according to states of watching, recording, or appointing to record a program.

In FIG. 3, in addition to the plurality of program display sections which configure the EPG, a menu display 61 which shows a list of manipulation menu items manipulated by the user, a thumbnail image 62 which indicates the content of a program which is being watched, a thumbnail image 63 which indicates the content of a program which is being recorded, and a thumbnail image 64 which indicates the content of a program which is appointed to be recorded are displayed on the display screen of the display unit 23.

Meanwhile, the depths thereof increase in the order of the menu display 61 and the thumbnail images 62, 63, and 64. Therefore, on the display screen of the display unit 23, the menu display 61 and the thumbnail images 62, 63, and 64 are viewed to be present on the front side in the order thereof.

Further, on the display screen of the display unit 23, the thumbnail images 62, 63, and 64 are overlapped and displayed in the order thereof.

For example, if the user manipulates the remote controller 2 such that “record” is designated on the menu display 61 when the menu display 61 is displayed on the display screen of the display unit 23, the remote controller 2 outputs a corresponding manipulation signal to the light receiving unit 24. The light receiving unit 24 receives the manipulation signal from the remote controller 2, and supplies the manipulation signal to the control unit 25.

Thereafter, when the manipulation signal is supplied from the light receiving unit 24, the control unit 25 reads the EPG from the storage unit 26, and supplies the EPG to the generation unit 27. The control unit 25 controls the generation unit 27 and the image processing unit 22, and displays the 3D image functioning as the EPG on the display unit 23, as shown in FIG. 3, like the case where the 3D image, as shown in FIG. 2, is generated.

That is, for example, the generation unit 27 generates the 3D image in which the parallax amount of each of the menu display 61 and the thumbnail images 62, 63, and 64 is set such that the depths of the menu display 61 and the thumbnail images 62, 63, and 64 become large in the order thereof under the control from the control unit 25.

Further, the generation unit 27 supplies the 3D image functioning as the generated EPG to the image processing unit 22.

The image processing unit 22 superimposes the 3D image functioning as the EPG from the generation unit 27 on an image corresponding to the image signal from the tuner 21 under the control from the control unit 25, supplies the superimposed image obtained as the result of the superimposition to the display unit 23, and displays the superimposed image on the display unit 23. Therefore, the stereoscopic EPG, as shown in FIG. 3, is displayed on the display screen of the display unit 23.

Next, a principle in which the program display sections and the thumbnail images can be displayed to be stereoscopically viewed using the 3D image which is generated by the generation unit 27 will be described with reference to FIGS. 4 to 6.

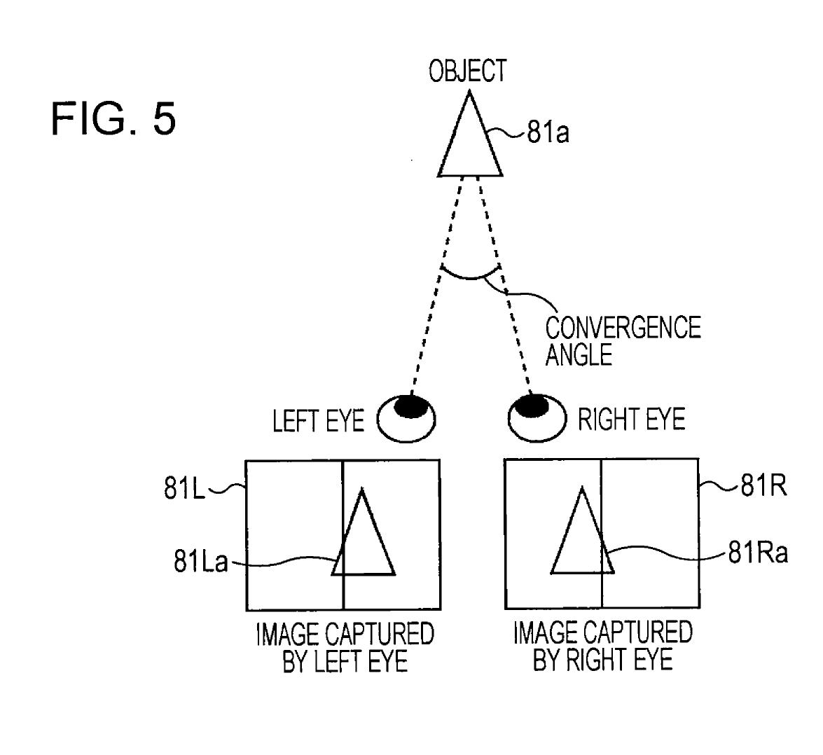

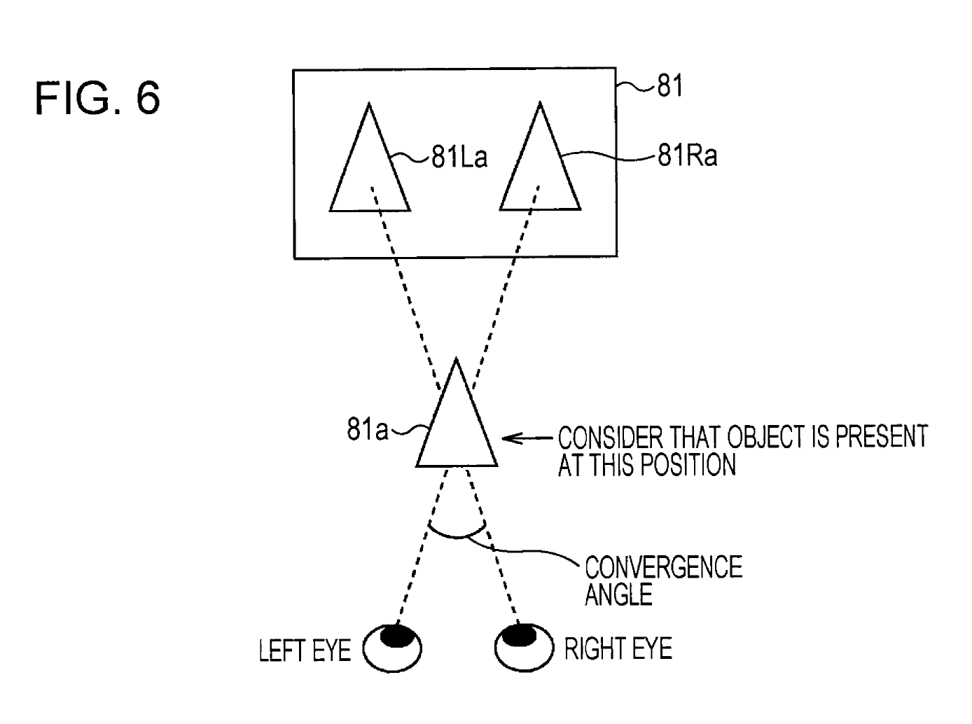

Meanwhile, as described above, a 3D image 81 is configured with, for example, a left eye 2D image 81L and a right eye 2D image 81R, as shown in FIG. 4, and parallax is provided between an object 81La on the left eye 2D image 81L and an object 81Ra on the right eye 2D image 81R such that the object 81a (refer to FIGS. 5 and 6) on the 3D image 81 which is viewed by the user (viewer) is stereoscopically viewed. Here, the parallax indicates the deviation between the position of the object 81La on the left eye 2D image 81L and the position of the object 81Ra on the right eye 2D image 81R, as shown in FIG. 4.

Further, when the 3D image 81 is shown to the user, for example, as shown in FIG. 5, the left eye 2D image 81L is shown such that the left eye 2D image 81L can be viewed by only the left eye of the user and the right eye 2D image 81R is shown such that the right eye 2D image 81R can be viewed by only the right eye of the user.

As shown in FIG. 6, the user can view as if the object 81a on the 3D image 81 is stereoscopically present in real space according to the angle of convergence corresponding to the amount of parallax (parallax amount) set to the left eye 2D image 81L and the right eye 2D image 81R.

Meanwhile, when the 3D image 81 corresponds to a still image or a video image, the left eye 2D image 81L and the right eye 2D image 81R are generated by photographing the object 81a from, for example, two different viewpoints.

Further, when the 3D image 81 is generated using computer graphics or the like, the left eye 2D image 81L and the right eye 2D image 81R are generated by rendering the left eye 2D image 81L and the right eye 2D image 81R according to two viewpoints which are virtually determined. In the present embodiment, the generation unit 27 generates the 3D image by, for example, performing rendering according to the two viewpoints which are virtually determined.

Meanwhile, the 3D image is displayed using a method corresponding to the display unit 23, such as a frame sequential method, a polarization method, or the like.

Description of Operation of TV Receiver 1

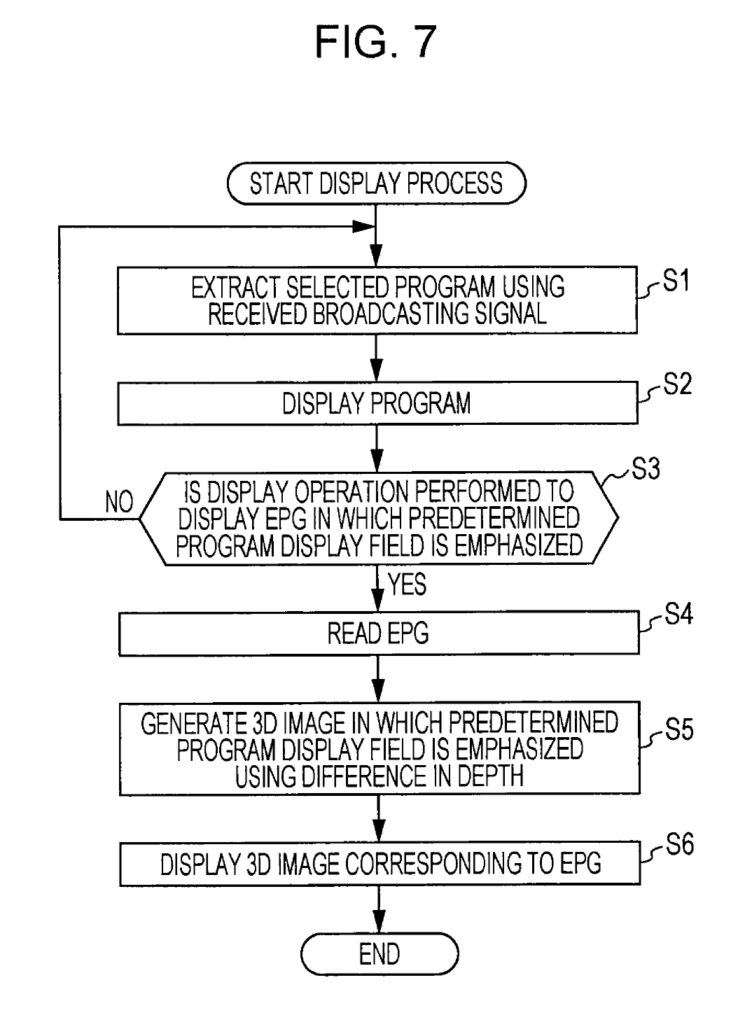

Next, a display process performed by the TV receiver 1 will be described with reference to the flowchart of FIG. 7.

This display process starts when, for example, the power of the TV receiver 1 is turned on. Meanwhile, FIG. 7 illustrates the case where the EPG, as shown in FIG. 2, is displayed.

In step S1, the tuner 21 receives a broadcast signal via an antenna or the like, extracts an image signal corresponding to a selected channel (frequency bandwidth) from the received broadcast signal, and supplies the image signal to the image processing unit 22.

In step S2, the image processing unit 22 supplies the image signal from the tuner 21 to the display unit 23, and displays a corresponding image.

In step S3, the control unit 25 determines whether display manipulation is performed or not in order to display an EPG, in which a predetermined program display section is emphasized, on the display screen of the display unit 23 in response to the manipulation signal from the light receiving unit 24.

In step S3, when the control unit 25 determines that the display manipulation is not performed in order to display the EPG, in which the predetermined program display section is emphasized, on the display screen of the display unit 23 in response to the manipulation signal from the light receiving unit 24, the process returns to step Si and the same process is repeated thereafter.

Further, in step S3, when the control unit 25 determines that the display manipulation is performed in order to display the EPG, in which the predetermined program display section is emphasized, on the display screen of the display unit 23 in response to the manipulation signal from the light receiving unit 24, the process proceeds to step S4.

In step S4, the control unit 25 reads the EPG from the storage unit 26, and supplies the EPG to the generation unit 27.

In step S5, the generation unit 27 generates a 3D image, in which program display sections which configure the EPG can be stereoscopically viewed, based on the EPG from the control unit 25 under the control from the control unit 25, and supplies the 3D image to the image processing unit 22.

That is, for example, the generation unit 27 generates the 3D image, in which the parallax amount of the program display sections 41 and 42 (see FIG. 2) which function as predetermined program display sections is greater than the parallax amount of program display sections excluding the program display sections 41 and 42, and supplies the 3D image to the image processing unit 22.

The generation unit 27 supplies the generated 3D image to the image processing unit 22.

In step S6, under the control of the control unit 25, the image processing unit 22 superimposes the 3D image which functions as the EPG from the generation unit 27 on an image which corresponds to the image signal from the tuner 21, supplies the superimposed image obtained as the result of the superimposition to the display unit 23, and displays the superimposed image. With that, the display process is terminated.

As described above, according to the display process, for example, a desired program display section of the plurality of program display sections which configure the EPG is emphasized and displayed in depth which is different from those of other program display sections.

Therefore, the visibility of the program display section which configures the EPG is improved, so that the user can rapidly recognize a desired program display section.

### 2. Modification

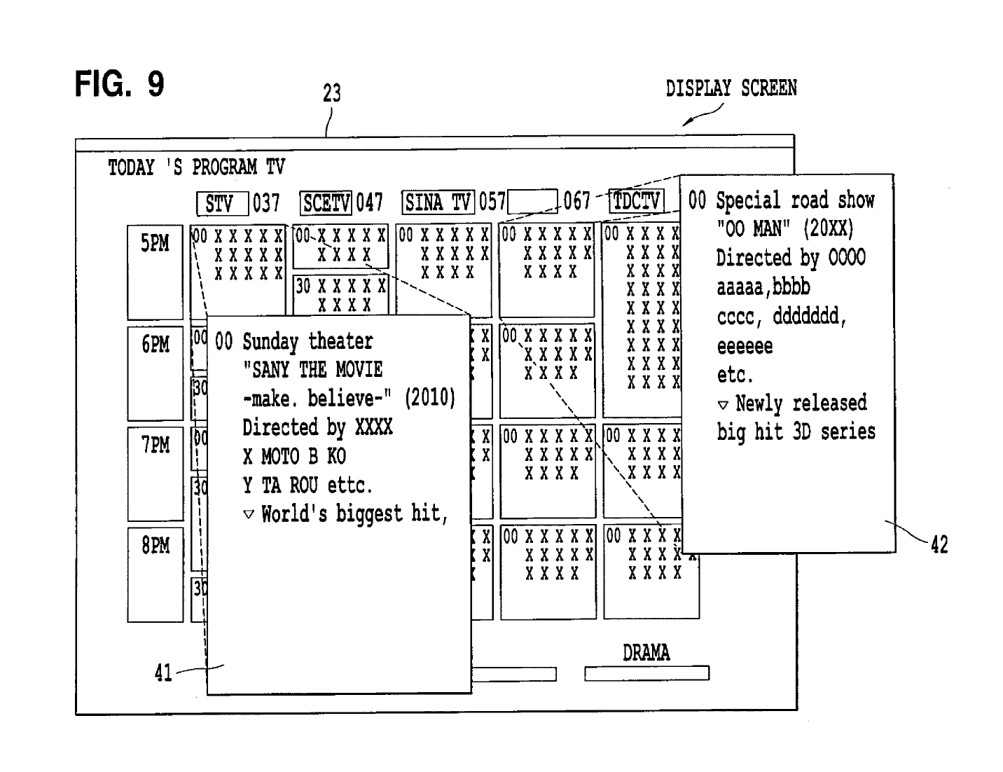

The program display sections of programs which belong to the same genre are displayed in the same depth in the present embodiment, as shown in FIG. 2. However, in addition, for example, the program display sections of programs which are broadcast in the same time period may be displayed in the same depth. For example, FIG. 9 shows that objects 41 and 42 which are broadcast at a same time are displayed at a same depth.

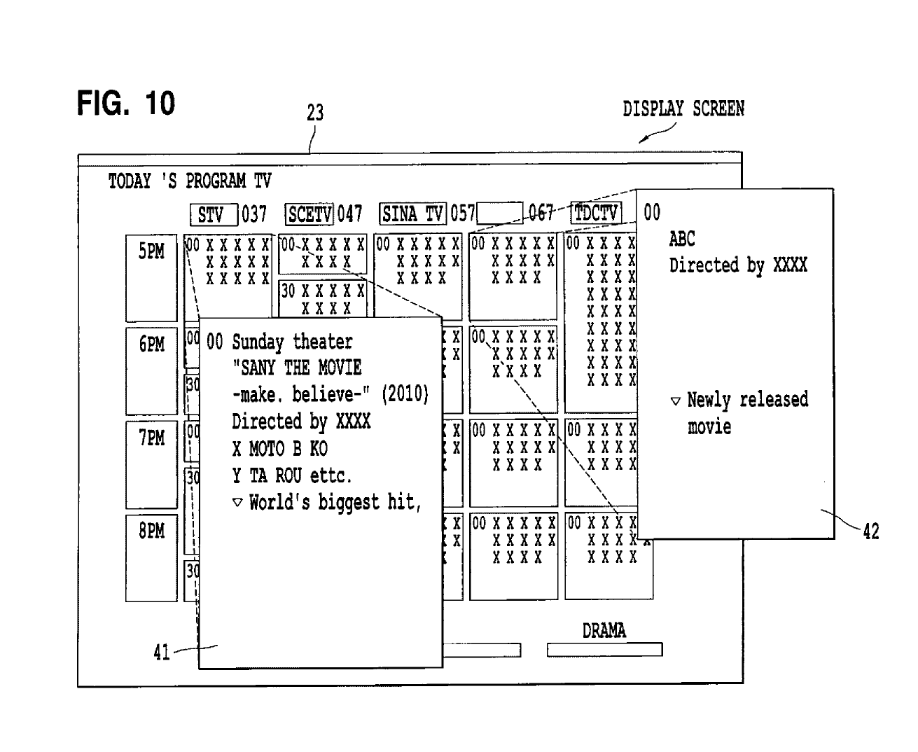

Further, for example, configuration can be made such that the control unit 25 searches a plurality of programs for programs which are appropriate for a keyword input by the user, and the program display sections of the programs, which are obtained as the results of the search performed by the control unit 25, are displayed in the same depth. For example, FIG. 10 shows that object 41 and 42 which match the keyword “movie” are displayed at different depths then all of the other program display sections which do not match the keyword “movie.”

In addition, for example, when the program display sections are designated by the designation operation of the user, pieces of detailed information about the programs corresponding to the program display sections may be overlapped and displayed in front of the program display sections.

Therefore, according to the depths of the program display sections and the corresponding pieces of detailed information about the programs, it can be easily recognized that the pieces of detailed information about the programs are displayed based on the designation of the program display sections. Therefore, the relationship between the program display sections and the pieces of detailed information is intuitively and easily recognized.

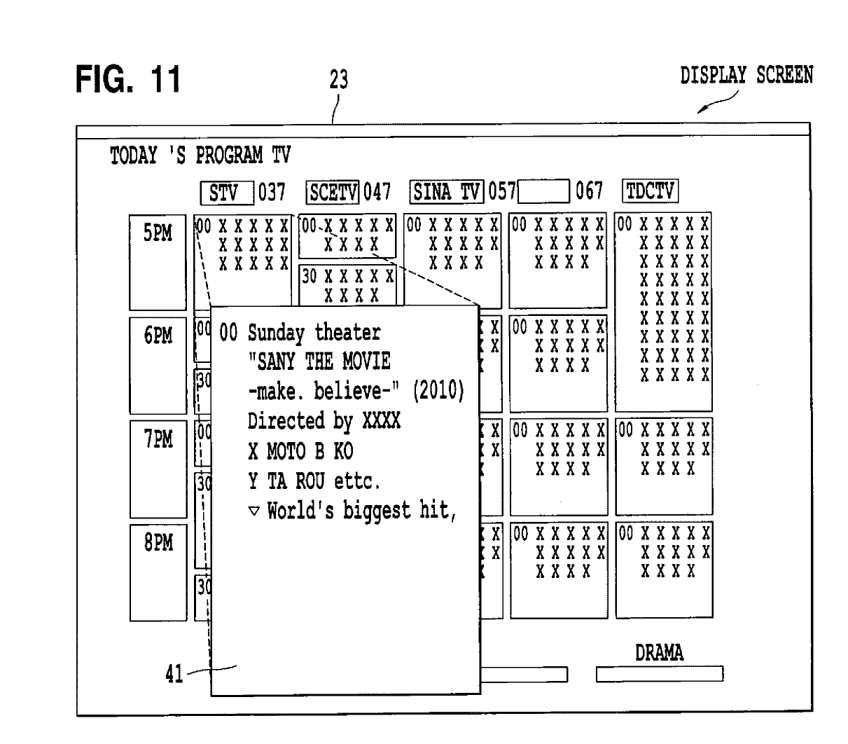

Further, for example, the program display section, which is selected by the user from among the plurality of program display sections which configure the EPG, may be displayed in depth which is different from those of other program display sections. For example, FIG. 11 shows that object 41 is displayed at a different depths and all the other program display section went object 41 is selected.

Further, for example, if all of the respective program display sections which configure the EPG are displayed in front in the same depth, the programs can be clearly distinguished from the EPG which is superimposed on the programs, so that the visibility of the EPG can be improved.

Although the generation unit 27 generates the EPG as the 3D image in the present embodiment, a generation target is not limited to the EPG.

That is, for example, in addition to the case where the EPG is generated as the 3D image, a 3D image which includes information displays indicating information about pieces of content, such as programs, music, video images, still images, or the like, can be generated. In detail, for example, a list which includes titles related to music as information displays can be generated as a 3D image.

Although description is made such that the TV receiver 1 generates the EPG as the 3D image and displays the EPG in the present embodiment, the present technology can be applied to any type of electronic device, such as a personal computer, a mobile phone or the like, which can display a 3D image, in addition to the TV receiver 1.

Meanwhile, the present technology can include the following configurations:

(1) An apparatus comprising:

an detection section configured to detect an operation input; and

a display controller configured to control a display to display a plurality of objects, the display controller configured to control the display to select at least one of the plurality of objects based on the operation input, to modify a depth component of a display position of the at least one object selected, and to display the at least one object selected at the display position having the depth component modified.

(2) The apparatus according to (1), wherein the display controller controls the display to select all objects in the plurality of objects that meet a predetermined condition, and to modify the depth component of the display position of all selected objects.

(3) The apparatus according to (1) or (2), wherein the display controller controls the display to modify the depth component of the display position of all selected objects such that all selected objects are displayed at a same depth, and displayed at a different depth than objects that do not meet the predetermined condition.

(4) The apparatus according to (2), wherein the display controller controls the display to select all objects in the plurality of objects that correspond to content in a particular genre.

(5) The apparatus according to (4), wherein the input device receives a selection of the particular genre from the user.

(6) The apparatus according to any of (1) to (3), wherein the display controller controls the display to display all objects corresponding to content broadcast at a same time at a same depth.

(7) The apparatus according to any of (1) to (3), or (6), wherein the display controller controls the display to display each of the plurality of objects at a different depth.

(8) The apparatus according to (7), wherein the display controller controls the display to display each of the plurality of objects at a different depth such that a largest object is at a smallest depth.

(9) The apparatus according to (7) or (8), wherein the display controller controls the display to display a first object corresponding to content currently being watched at a first depth, a second object corresponding to content currently being recorded at a second depth, and a third object corresponding to content to be recorded in the future at a third depth, the third depth is greater than the second depth, and the second depth is greater than the first depth.

(10) The apparatus according to any of (1) to (3), (6) or (7), wherein the input device receives a keyword from the user, the display controller performs a search for content associated with the keyword, and the display controller controls the display to display objects corresponding to content associated with the keyword at a same depth.

(11) The apparatus according to any of (1) to (3), (6), (7) or (10), wherein the display controller controls the display to display one of the plurality of objects selected by the user with the input device at a different depth than a rest of the plurality of objects.

(12) The apparatus according to any of (1) to (3), (6), (7), (10) or (11), wherein the display controller selects display objects which have same horizontal and vertical components of a 3D display position from among the plurality of objects according to a user input, and modifies the depth components of the 3D display positions of the selected objects.

(13) The apparatus according to any of (1) to (3), (6), (7), (10), (11) or (12), wherein when first and second objects have same horizontal and vertical components of a 3-D display position, the display controller superimposes the second object, which is displayed when the second object is selected, on the first object, and displays the superimposed image.

The present technology can also include the following configurations:

(1) A display control apparatus that controls display of a 3D image, including a generation unit that generates a plurality of display objects and pieces of 3D display position information which indicate the 3D display positions of the plurality of display objects, respectively; and a display control unit that displays the display objects generated by the generation unit on the 3D display positions corresponding to the pieces of the 3D display position information. The generation unit selects at least one or more display objects from among the plurality of display objects according to the manipulation of a user, and may modify the depth components of the 3D display positions of the selected display objects.

(2) In the display control apparatus of (1), the generation unit may select the display objects which indicate content which satisfies a predetermined condition from among the plurality of display objects according to the manipulation of the user, and may modify the depth components of the 3D display positions of the selected display objects.

(3) In the display control apparatus of (2), the generation unit may select the display objects which indicate the content which belongs to the same genre from among the plurality of display objects according to the manipulation of the user, and may modify the depth components of the 3D display positions of the selected display objects.

(4) In the display control apparatus of (2), the generation unit may select the display objects which indicate the content which is broadcast in the same time period from among the plurality of display objects according to the manipulation of the user, and may modify the depth components of the 3D display positions of the selected display objects.

(5) In the display control apparatus of (2), the generation unit may select the display objects which indicate the content, the state of which is the same, from among the plurality of display objects according to the manipulation of the user, and may modify the depth components of the 3D display positions of the selected display objects.

(6) In the display control apparatus of (5), the generation unit may select the display objects which indicate any content which is being watched, content which is being recorded, and content which is being appointed to be recorded, from among the plurality of display objects according to the manipulation of the user, and may modify the depth components of the 3D display positions of the selected display objects.

(7) The display control apparatus of (2), further includes a searching unit that searches a plurality of pieces of content for content desired by the user, and the generation unit may select the display objects which indicate the content obtained as the results of the search performed by the searching unit, and may modify the depth components of the 3D display positions of the selected display objects.

(8) In the display control apparatus of (1) to (7), the generation unit may select the display objects which are selected from among the plurality of display objects according to the selection manipulation of the user, and may modify the depth components of the 3D display positions of the selected display objects.

(9) In the display control apparatus of (1), the generation unit may select the display objects which have the same horizontal and vertical components of the 3D display position from among the plurality of display objects according to the manipulation of the user, and may modify the depth components of the 3D display positions of the selected display objects.

(10) In the display control apparatus of (9), with respect to first and second display objects which have the same horizontal and vertical components of the 3D display position, the display control unit may superimpose the second display object which is displayed when the first display object is designated by the user, on the first display object, and may display the superimposed image.

However, the series of processes which are described above can be performed using both hardware and software. When the series of processes are performed using software, a program which configures the software is installed from a program recording media on, for example, a general-purpose computer which can execute various types of functions by installing the computer which is provided with dedicated hardware or various types of programs.

<Example of Configuration of Computer>

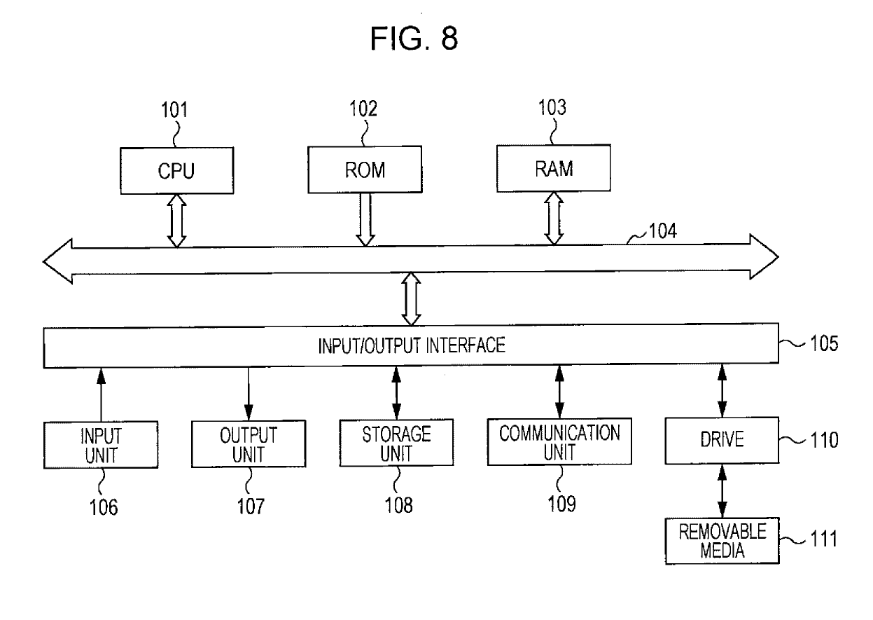

FIG. 8 is a block diagram illustrating an example of the configuration of the hardware of a computer which executes the above-described series of processes using a program.

A Central Processing Unit (CPU) 101 executes various types of processes according to a program which is stored in a Read Only Memory (ROM) 102 or a storage unit 108. A Random Access Memory (RAM) 103 appropriately stores programs, data, or the like executed by the CPU 101. The CPU 101, the ROM 102, and the RAM 103 are connected to each other via a bus 104.

Further, the CPU 101 is connected to an input/output interface 105 via the bus 104. The input/output interface 105 is connected to the input unit 106 which includes a keyboard, a mouse, a microphone or the like and an output unit 107 which includes a display, a speaker or the like. The CPU 101 executes various types of processes corresponding to instructions which are input from the input unit 106. Further, the CPU 101 outputs the result of the processes to the output unit 107.

The storage unit 108 which is connected to the input/output interface 105 includes, for example, a hard disk, and stores the programs or various types of data which are executed by the CPU 101. A communication unit 109 communicates with external apparatuses via a network, such as the Internet, a local area network, or the like.

Further, programs can be obtained through the communication unit 109 and stored in the storage unit 108.

When a removable media 111, such as a magnetic disk, an optical disc, a magneto-optical disc, a semiconductor memory or the like, is mounted, a drive 110 which is connected to the input/output interface 105 drives the removable media 111 and obtains programs, data or the like recorded therein. The obtained programs or data are transmitted to and stored in the storage unit 108, as necessary.

As shown in FIG. 8, a recording media which is installed in the computer and which records (stores) programs, the states of which is enabled to be executable by the computer, includes a removable media 111 which is a package media including a magnetic disk (including a flexible disk), an optical disc (including a Compact Disc-Read Only Memory (CD-ROM) and a Digital Versatile Disc (DVD), a magneto-optical disc (including a Mini-Disc (MD)), a semiconductor memory or the like, the ROM 102 in which programs are temporally or permanently stored, a hard disk which configures the storage unit 108, or the like. The programs are stored in the recording media using wired or wireless communication media, such as a local area network, the Internet, and digital satellite broadcasting, via the communication unit 109 which is an interface such as a router, a modem or the like, as necessary.

Meanwhile, in the present specification, the steps, in which the series of processes which are described above are described, include processes which are performed in time-oriented manner along the described procedure, and processes which are executed in parallel or individually even though the processes are not necessarily processed in time-oriented manner.

Meanwhile, the present invention is not limited to the present embodiment, and can be modified in various types of manner in the range which does not depart from the gist of the present invention.

### REFERENCE SIGNS LIST

1 TV receiver

21 tuner

22 image processing unit

23 display unit

24 light receiving unit

25 control unit

26 storage unit

27 generation unit

1. An apparatus comprising:
an detection section configured to detect an operation input; and
a display controller configured to control a display to display a plurality of objects, the display controller configured to control the display to select at least one of the plurality of objects based on the operation input, to modify a depth component of a display position of the at least one object selected, and to display the at least one object selected at the display position having the depth component modified.

2. The apparatus according to claim 1, wherein the display controller controls the display to select all objects in the plurality of objects that meet a predetermined condition, and to modify the depth component of the display position of all selected objects.

3. The apparatus according to claim 1, wherein the display controller controls the display to modify the depth component of the display position of all selected objects such that all selected objects are displayed at a same depth, and displayed at a different depth than objects that do not meet the predetermined condition.

4. The apparatus according to claim 2, wherein the display controller controls the display to select all objects in the plurality of objects that correspond to content in a particular genre.

5. The apparatus according to claim 4, wherein the input device receives a selection of the particular genre from the user.

6. The apparatus according to claim 1, wherein the display controller controls the display to display all objects corresponding to content broadcast at a same time at a same depth.

7. The apparatus according to claim 1, wherein the display controller controls the display to display each of the plurality of objects at a different depth.

8. The apparatus according to claim 7, wherein the display controller controls the display to display each of the plurality of objects at a different depth such that a largest object is at a smallest depth.

9. The apparatus according to claim 7, wherein the display controller controls the display to display a first object corresponding to content currently being watched at a first depth, a second object corresponding to content currently being recorded at a second depth, and a third object corresponding to content to be recorded in the future at a third depth, the third depth is greater than the second depth, and the second depth is greater than the first depth.

10. The apparatus according to claim 1, wherein the input device receives a keyword from the user, the display controller performs a search for content associated with the keyword, and the display controller controls the display to display objects corresponding to content associated with the keyword at a same depth.

11. The apparatus according to claim 1, wherein the display controller controls the display to display one of the plurality of objects selected by the user with the input device at a different depth than a rest of the plurality of objects.

12. The apparatus according to claim 1, wherein the display controller selects display objects which have same horizontal and vertical components of a 3D display position from among the plurality of objects according to a user input, and modifies the depth components of the 3D display positions of the selected objects.

13. The apparatus according to claim 1, wherein when first and second objects have same horizontal and vertical components of a 3-D display position, the display controller superimposes the second object, which is displayed when the second object is selected, on the first object, and displays the superimposed image.

14. A method comprising:
detecting an operation input; and
controlling a display to display a plurality of objects, the controlling including controlling the display to select at least one of the plurality of objects based on the operation input, modifying a depth component of a display position of the at least one object selected, and displaying the at least one object selected at the display position having the depth component modified.

15. A non-transitory computer readable medium encoded with a program that, when loaded on a processor, causes the processor to perform method comprising:
detecting an operation input; and
controlling a display to display a plurality of objects, the controlling including controlling the display to select at least one of the plurality of objects based on the operation input, modifying a depth component of a display position of the at least one object selected, and displaying the at least one object selected at the display position having the depth component modified.
